(19) United States
(12) Patent Application Publication
(10) Pub. No.: US 2026/0240160 A1
(43) Pub. Date: Aug. 20, 2026

(54) AGRICULTURAL MIXTURES AND METHODS OF USE THEREOF

(71) Applicant: Valent BioSciences LLC, Libertyville, IL (US)

(72) Inventors: Steve McArtney, Antioch, IL (US); Srirama Krishna Reddy, Libertyville, IL (US); Jefferson da Silva, Libertyville, IL (US); Giovani Dalla-Corte, Primavera do Leste (BR); Lucas Martinez, Westfield, IN (US); Ronald Weber, Vernon Hills, IL (US)

(21) Appl. No.: 19/542,817

(22) Filed: Feb. 18, 2026

Related U.S. Application Data
(60) Provisional application No. 63/760,205, filed on Feb. 19, 2025.

(51) Int. Cl. A01N 43/90; A01N 37/04; A01N 43/36; A01P 21/00

(52) U.S. Cl. CPC A01N 43/90; A01N 37/04; A01N 43/36; A01P 21/00

(57) ABSTRACT

The present invention is directed to mixtures comprising 6-benzyladenine and a second compound selected from the group consisting of proline and malic acid. The present invention is further directed to methods of increasing plant, growth, yield and/or quality comprising applying sequentially or concurrently an effective amount of mixtures of the present invention to the plant or an area where the plant will grow.

### FIELD OF THE INVENTION

The present invention is directed to mixtures comprising 6-benzyladenine and a second compound selected from the group consisting of proline and malic acid. The present invention is further directed to methods of increasing plant, growth, yield and/or quality comprising applying sequentially or concurrently an effective amount of mixtures of the present invention to the plant or an area where the plant will grow.

### BACKGROUND OF THE INVENTION

Growers continually attempt to grow the most productive crops possible in order to maximize yields. Plant growth regulators are among the best tools that growers can use to influence the growth of plants. The effects of plant growth regulators on plants under different conditions can vary widely. Furthermore, it is difficult to predict what compounds might enhance plant growth regulators effect.

Cytokinins are plant growth regulators that regulate cell division in plant shoots and organs. Exogenous cytokinins are applied in agricultural settings to increase yield of plants. 6-benzyladenine is a synthetic cytokinin. 6-benzyladenine is known to increase crop yield. See, Pan & Xu, Benzyladenine Treatment Significantly Increases the Seed Yield of the Biofuel Plant Jatropha curcas, J Plant Growth Reg, 2010, 30, 166-174.

Agricultural methods of increasing plant growth, yield and/or quality are well known in the art. However, improvements of these methods are necessary as demands for crops increases. Thus, there is a need in the art for mixtures that increase plant growth, yield and/or quality.

### SUMMARY OF THE INVENTION

The present invention is directed to an agricultural mixture comprising 6-benzyladenine (“6BA”) and a second compound selected from the group consisting of proline and malic acid.

The present invention is further directed to an agricultural composition comprising 6BA, a second compound selected from the group consisting of proline and malic acid and a carrier.

The present invention is further directed to methods of increasing plant growth, yield and/or quality comprising applying sequentially or concurrently an effective amount of a mixture of the present invention to the plant or an area where the plant will grow.

### DETAILED DESCRIPTION OF THE INVENTION

The Applicant has discovered that agricultural mixtures comprising 6-benzyladenine (“6BA”) and proline or malic acid provide synergistic increase in plant, growth, yield and/or quality.

In one embodiment, the present invention is directed to an agricultural mixture comprising 6BA and a second compound selected from the group consisting of proline and malic acid.

In a preferred embodiment, the second compound is proline.

In another preferred embodiment, the second compound is malic acid.

In another embodiment, the present invention is directed to an agricultural composition comprising 6BA, a second compound selected from the group consisting of proline and malic acid and a carrier.

As used herein the term “6-benzyladenine” or “6BA” refers to the chemical compound having CAS #1214-39-7 and IUPAC name N-benzyl-7H-purin-6-amine.

As used herein the term “proline” refers to the chemical compound having CAS #147-85-3 and IUPAC name (2S)-pyrrolidine-2-carboxylic acid.

As used herein the term “malic acid” refers to the chemical compound having CAS #97-67-6 and IUPAC name 2-hydroxybutanedioic acid.

In another embodiment, 6-benzyladenine may exist in a composition at an effective amount. In a preferred embodiment, an effective amount is from about 0.1% to about 10% w/w, preferably from about 1% to about 10% w/w, more preferably from about 1% to about 5% w/w and even more preferably from about 2% to about 5% w/w and yet even more preferably from about 2% to about 4% w/w.

In another embodiment, proline may exist in a composition at an effective amount. In a preferred embodiment, an effective amount is from about 0.1% to about 50% w/w, preferably from about 1% to about 50% w/w, more preferably from about 10% to about 40% w/w and even more preferably from about 20% to about 40% w/w and yet even more preferably from about 24% to about 36% w/w.

In another embodiment, malic acid may exist in a composition at an effective amount. In a preferred embodiment, an effective amount is from about 0.1% to about 75% w/w, preferably from about 1% to about 60% w/w, more preferably from about 15% to about 60% w/w and even more preferably from about 15% to about 30% w/w.

In another preferred embodiment, the concentration ratio of 6BA and proline is from about 100:1 to about 1:100, more preferably from about 20:1 to about 1:20, even more preferably from about 1:1 to about 1:18, yet even more preferably from about 1:1.1 to about 1:18, yet even more preferably from about 1:8 to about 1:12 and most preferably at about 1:8.

In another preferred embodiment, the concentration ratio of 6BA and malic acid is from about 100:1 to about 1:100, more preferably from about 20:1 to about 1:20, even more preferably from about 1:1 to about 1:20, yet even more preferably from about 1:1.1 to about 1:20, yet even more preferably from about 1:5 to about 1:15 and most preferably at about 1:10.

In another embodiment, the present invention is directed to methods of increasing plant growth, yield and/or quality comprising applying sequentially or concurrently an effective amount of a mixture of the present invention to the plant or an area where the plant will grow.

In another embodiment, the plant is a monocotyledonous plant or a dicotyledonous plant. In a preferred embodiment the plant is selected from the group consisting of root, corm and tuber vegetable plants, bulb vegetable plants, leafy non-brassica vegetable plants, leafy brassica vegetable plants, succulent or dried legume plants, fruiting vegetable plants, cucurbit vegetable plants, citrus fruit plants, pome fruit plants, stone fruit plants, berry and small fruit plants, tree nut plants, cereal crops, forage and fodder grasses and hay, non-grass animal feed plants, herb plants, spice plants, flower plants, bedding plants, ornamental flower plants, artichoke, asparagus, tropical fruit plants, hops, malanga, peanut, pomegranate plants, oil seed vegetable plants, tobacco plants, turf grass and watercress plant. In a more preferred embodiment, the plant corn.

In a preferred embodiment, the root, corm and tuber vegetable plants are selected from the group consisting of arracacha, arrowroot, Chinese artichoke, Jerusalem artichoke, garden beet, sugar beet, edible burdock, edible canna, carrot, bitter cassava, sweet cassava, celeriac, root chayote, turnip-rooted chervil, chicory, chufa, dasheen (taro), ginger, ginseng, horseradish, leren, turnip-rooted parsley, parsnip, potato, radish, oriental radish, rutabaga, salsify, black salsify, Spanish salsify, skirret, sweet potato, tanier, turmeric, turnip, yam bean, true yam, and cultivars, varieties and hybrids thereof.

In another preferred embodiment, the bulb vegetable plants are selected from the group consisting of fresh chive leaves, fresh Chinese chive leaves, bulb daylily, elegans hosta, bulb fritillaria, fritillaria leaves, bulb garlic, great-headed bulb garlic, serpent bulb garlic, kurrat, lady's leek, leek, wild leek, bulb lily, Beltsville bunching onion, bulb onion, Chinese bulb onion, fresh onion, green onion, macrostem onion, pearl onion, potato bulb onion, potato bulb, tree onion tops, Welsh onion tops, bulb shallot, fresh shallot leaves, and cultivars, varieties and hybrids thereof.

In a further embodiment, the leafy non-brassica vegetable plants are selected from the group consisting of Chinese spinach Amaranth, leafy Amaranth, arugula (roquette), cardoon, celery, Chinese celery, celtuce, chervil, Chinese spinach, edible-leaved chrysanthemum, garland chrysanthemum, corn salad, garden cress, upland cress, dandelion, dandelion leaves, sorrels (dock), endive (escarole), Florence fennel, head lettuce, leaf lettuce, orach, parsley, garden purslane, winter purslane, radicchio (red chicory), rhubarb, spinach, New Zealand spinach, vine spinach, Swiss chard, Tampala, and cultivars, varieties and hybrids thereof.

In another embodiment, the leafy brassica vegetable plants are selected from the group consisting of broccoli, Chinese broccoli (gai lon), broccoli rabe (rapini), Brussels sprouts, cabbage, Chinese cabbage (bok choy), Chinese napa cabbage, Chinese mustard cabbage (gai choy), cauliflower, cavolo broccoli, collards, kale, kohlrabi, mizuna, mustard greens, mustard spinach, rape greens, turnip greens and cultivars, varieties and hybrids thereof. In yet another embodiment, the succulent or dried vegetable legumes are selected from the group consisting of Lupinus beans, Phaseolus beans, Vigna beans, broad beans (fava), chickpea (garbanzo), guar, jackbean, lablab bean, lentil, Pisum peas, pigeon pea, soybean, immature seed soybean, sword bean, peanut, and cultivars, varieties and hybrids thereof. In a preferred embodiment, the Lupinus beans include grain lupin, sweet lupin, white lupin, white sweet lupin, and hybrids thereof. In another preferred embodiment, the Phaseolus beans include field bean, kidney bean, lima bean, navy bean, pinto bean, runner bean, snap bean, tepary bean, wax bean, and hybrids thereof. In yet another preferred embodiment, the Vigna beans include adzuki bean, asparagus bean, blackeyed bean, catjang, Chinese longbean, cowpea, Crowder pea, moth bean, mung bean, rice bean, southern pea, urd bean, yardlong bean, and hybrids thereof. In another embodiment, the Pisum peas include dwarf pea, edible-podded pea, English pea, field pea, garden pea, green pea, snow pea, sugar snap pea, and hybrids thereof. In a preferred embodiment, the dried vegetable legume is soybean. In another more preferred embodiment, the dried vegetable legume is genetically modified soybean.

In a further embodiment, the fruiting vegetable plants are selected from the group consisting of bush tomato, cocona, currant tomato, garden huckleberry, goji berry, groundcherry, martynia, naranjilla, okra, pea eggplant, pepino, bell peppers, non-bell peppers, roselle, eggplant, scarlet eggplant, African eggplant, sunberry, tomatillo, tomato, tree tomato, and cultivars, varieties and hybrids thereof. In a preferred embodiment, the peppers include bell peppers, chili pepper, cooking pepper, pimento, sweet peppers, and hybrids thereof.

In an embodiment, the cucurbit vegetable plants are selected from the group consisting of Chayote, Chayote fruit, waxgourd (Chinese preserving melon), citron melon, cucumber, gherkin, edible gourds, Momordica species, muskmelons, pumpkins, summer squashes, winter squashes, watermelon, and cultivars, varieties and hybrids thereof. In a preferred embodiment, edible gourds include hyotan, cucuzza, hechima, Chinese okra, and hybrids thereof. In another preferred embodiment, the Momordica vegetables include balsam apple, balsam pear, bittermelon, Chinese cucumber, and hybrids thereof. In another preferred embodiment, the muskmelon include true cantaloupe, cantaloupe, casaba, crenshaw melon, golden pershaw melon, honeydew melon, honey balls, mango melon, Persian melon, pineapple melon, Santa Claus melon, snake melon, and hybrids thereof. In yet another preferred embodiment, the summer squash include crookneck squash, scallop squash, straightneck squash, vegetable marrow, zucchini, and hybrids thereof. In a further preferred embodiment, the winter squash includes butternut squash, calabaza, hubbard squash, acorn squash, spaghetti squash, and hybrids thereof.

In another embodiment, the citrus fruit plants are selected from the group consisting of limes, calamondin, citron, grapefruit, Japanese summer grapefruit, kumquat, lemons, Mediterranean mandarin, sour orange, sweet orange, pummelo, Satsuma mandarin, tachibana orange, tangelo, mandarin tangerine, tangor, trifoliate orange, uniq fruit, and cultivars, varieties and hybrids thereof. In a preferred embodiment, the limes are selected from the group consisting of Australian desert lime, Australian finger lime, Australian round lime, Brown River finger lime, mount white lime, New Guinea wild lime, sweet lime, Russell River lime, Tahiti lime, and hybrids thereof.

In an embodiment, the pome fruit plants are selected from the group consisting of apple, azarole, crabapple, loquat, mayhaw, medlar, pear, Asian pear, quince, Chinese quince, Japanese quince, tejocote, and cultivars, varieties and hybrids thereof.

In another embodiment, the stone fruit plants are selected from the group consisting of apricot, sweet cherry, tart cherry, nectarine, peach, plum, Chicksaw plum, Damson plum, Japanese plum, plumcot, fresh prune, and cultivars, varieties and hybrids thereof.

In a further embodiment, the berries and small fruit plants are selected from the group consisting of Amur river grape, aronia berry, bayberry, bearberry, bilberry, blackberry, blueberry, lowbush blueberry, highbush blueberry, buffalo currant, buffaloberry, che, Chilean guava, chokecherry, cloudberry, cranberry, highbush cranberry, black currant, red currant, elderberry, European barberry, gooseberry, grape, edible honeysuckle, huckleberry, jostaberry, Juneberry (Saskatoon berry), lingonberry, maypop, mountain pepper berries, mulberry, muntries, native currant, partridgeberry, phalsa, pincherry, black raspberry, red raspberry, riberry, salal, sea buckthorn, serviceberry, strawberry, wild raspberry, and cultivars, varieties and hybrids thereof. In a preferred embodiment, the blackberries include Andean blackberry, arctic blackberry, bingleberry, black satin berry, boysenberry, brombeere, California blackberry, Chesterberry, Cherokee blackberry, Cheyenne blackberry, common blackberry, coryberry, darrowberry, dewberry, Dirksen thornless berry, evergreen blackberry, Himalayaberry, hullberry, lavacaberry, loganberry, lowberry, Lucreliaberry, mammoth blackberry, marionberry, mora, mures deronce, nectarberry, Northern dewberry, olallieberry, Oregon evergreen berry, phenomenalberry, rangeberry, ravenberry, rossberry, Shawnee blackberry, Southern dewberry, tayberry, youngberry, zarzamora, and hybrids thereof.

In another embodiment, the tree nut plants are selected from the group consisting of almond, beech nut, Brazil nut, Brazilian pine, bunya, butternut, bur oak, Cajou nut, candlenut, cashew, chestnut, chinquapin, coconut, coquito nut, dika nut, gingko, Guiana chestnut, hazelnut (filbert), heartnut, hickory nut, Japanese horse-chestnut, macadamia nut, mongongo nut, monkey-pot, monkey puzzule nut, Okari nut, Pachira nut, peach palm nut, pecan, Pili nut, pistachio, Sapucaia nut, tropical almond, black walnut, English walnut, yellowhorn, and cultivars, varieties and hybrids thereof.

In a further embodiment, the cereal grains are selected from the group consisting of barley, buckwheat, pearl millet, proso millet, oats, corn, field corn, sweet corn, seed corn, popcorn, rice, rye, sorghum (milo), sorghum species, grain sorghum, sudangrass (seed), teosinte, triticale, wheat, wild rice, and cultivars, varieties and hybrids thereof. In a preferred embodiment, the cereal grain is corn. In a more preferred embodiment, the cereal grain is genetically modified corn.

In yet another embodiment, the grass forage, fodder and hay are selected from the group consisting of grasses that are members of the Gramineae family and those species included in the cereal grains group, pasture and range grasses, and grasses grown for hay or silage. In further embodiments, the Gramineae grasses may be green or cured.

In an embodiment, the non-grass animal feeds are selected from the group consisting of alfalfa, velvet bean, trifolium clover, melilotus clover, kudzu, lespedeza, lupin, sainfoin, trefoil, vetch, crown vetch, milk vetch, and cultivars, varieties and hybrids thereof.

In another embodiment, the herbs and spice plants are selected from the group consisting of allspice, angelica, anise, anise seed, star anise, annatto seed, balm, basil, borage, burnet, chamomile, caper buds, caraway, black caraway, cardamom, cassia bark, cassia buds, catnip, celery seed, chervil, chive, Chinese chive, cinnamon, clary, clove buds, coriander leaf, coriander seed, costmary, culantro leaves, culantro seed, cilantro leaves, cilantro seed, cumin, dillweed, dill seed, fennel, common fennel, Florence fennel seed, fenugreek, grains of paradise, horehound, hyssop, juniper berry, lavender, lemongrass, leaf lovage, seed lovage, mace, marigold, marjoram, mint, mustard seed, nasturtium, nutmeg, parsley, pennyr oyal, black pepper, white pepper, poppy seed, rosemary, rue, saffron, sage, summer savory, winter savory, sweet bay, tansy, tarragon, thyme, vanilla, wintergreen, woodruff, wormwood, and cultivars, varieties and hybrids thereof. In a preferred embodiment, the mints are selected from the group consisting of spearmint, peppermint, and hybrids thereof.

In yet another embodiment, artichokes are selected from the group consisting of Chinese artichoke, Jerusalem artichoke, and cultivars, varieties and hybrids thereof.

In an embodiment, the tropical fruit plants are selected from the group consisting of anonna, avocado, fuzzy kiwifruit, hardy kiwifruit, banana, plantain, caimito, carambola (star fruit), guava, longan, sapodilla, papaya, passion fruit, mango, lychee, jackfruit, dragon fruit, mamey sapote, coconut cherimoya, canistrel, monstera, wax jambu, pomegranate, rambutan, pulasan, Pakistani mulberry, langsat, chempedak, durian, fig pineapple, jaboticaba, mountain apples, and cultivars, varieties and hybrids thereof.

In a further embodiment, the oil seed vegetable plants are selected from the group consisting of borage, calendula, castor oil plant, tallowtree, cottonseed, crambe, cuphea, echium, euphorbia, evening primrose, flax seed, gold of pleasure, hare's ear, mustard, jojoba, lesquerella, lunaria, meadowfoam, milkweed, niger seed, oil radish, poppy seed, rosehip, sesame, stokes aster, sweet rocket, tallowwood, tea oil plant, vermonia, canola, or oil rapeseed, safflower, sunflower, and cultivars, varieties and hybrids thereof.

The plant of the variety mentioned above may be a plant which can be produced by natural hybridization, a plant which can occur as the result of a mutation, an F1 hybrid plant, or a transgenic plant (also referred to as a “genetically modified plant”). These plants generally have properties such as a property that the tolerance to an herbicide is imparted, a property that a toxic substance against pests is accumulated, a property that the sensitivity to a plant disease is suppressed, a property that yield potential is increased, a property that the resistance to a biological or non-biological stress factor is improved, a property that a substance is accumulated, and improvement in a storage property or processability.

The term “F1 hybrid plant” refers to a plant of a first filial generation which is produced by hybridizing two different varieties with each other and is generally a plant which has a more superior trait to that of either one of parents thereof, i.e., has a hybrid vigor property. The term “transgenic plant” refers to a plant which is produced by introducing a foreign gene from another organism such as a microorganism into a plant and which has a property that cannot be acquired easily by hybridization breeding, induction of a mutation or a naturally occurring recombination under a natural environment.

Examples of the technique for producing the above-mentioned plants include a conventional breeding technique, a transgenic technique, a genome-based breeding technique, a new breeding technique, and a genome editing technique. The conventional breeding technique is a technique for producing a plant having a desirable property by mutation or hybridization. The transgenic technique is a technique for imparting a new property to a specific organism (e.g., a microorganism) by isolating a gene (DNA) of interest from the organism and then introducing the gene (DNA) into the genome of another target organism, and an antisense technique or an RNA interference technique which is a technique for imparting a new or improved property to a plant by silencing another gene occurring in the plant.

The genome-based breeding technique is a technique for increasing the efficiency of breeding using genomic information and includes a DNA marker (also referred to as “genome marker” or “gene marker”) breeding technique and genomic selection. For example, the DNA marker breeding is a method in which an offspring having a desired useful trait gene is selected from many hybrid offspring using a DNA marker that is a DNA sequence capable of serving as an indicator of the position of a specific useful trait gene on a genome. The analysis of a hybrid offspring of a plant at a seedling stage thereof using the DNA marker has such a characteristic that it becomes possible to shorten the time required for breeding effectively.

The genomic selection is such a technique that a prediction equation is produced from a phenotype and genomic information both obtained in advance and then a property is predicted from the prediction equation and the genomic information without carrying out the evaluation of the phenotype. The genomic selection can contribute to the increase in efficiency of breeding. A “new breeding technique” is a collective term for a variety of breeding techniques including molecular biological techniques. Examples of the new breeding technique include techniques such as cisgenesis/intragenesis, oligonucleotide-directed mutagenesis, RNA-dependent DNA methylation, genome editing, grafting to a GM rootstock or scion, reverse breeding, agroinfiltration, and seed production technology (SPT). The genome editing technique is a technique that converts genetic information in a sequence-specific manner, and enables addition, deletion and or substitution of a DNA base-pair sequence, addition, deletion and or substitution of an amino acid sequence, introduction of a foreign DNA base-pair sequence including genes and regulatory regions, and the like. Examples of the tool for the technique include zinc-finger nuclease (ZFN), TALEN, CRISPR/Cas9, CRISPER/Cpf1 and meganuclease which can cleave DNA in a sequence-specific manner, and a sequence-specific genome modification technique using CAS9 nickase, Target-AID and the like which is produced by any one of the modification of the above-mentioned tools. A skilled artisan would understand that future techniques will be developed that are capable of editing the genomic sequence, modifying transcription of a DNA sequence to an RNA sequence, modifying an RNA sequence, modifying translation of an RNA sequence to an amino acid sequence, modifying an amino acid sequence and or modifying the folding of an amino acid sequence and or agglomeration of amino acid sequences to a protein and that any or all of these techniques may be beneficial in modifying the phenotype of a plant. Plants whose phenotypes have been modified by all known and future techniques capable of modifying the phenotype of a plant are envisaged herein.

Examples of the above-mentioned plants include plants listed in genetically modified crops registration database (GM APPROVAL DATABASE) in an electric information site in INTERNATIONAL SERVICE for the ACQUISITION of AGRI-BIOTECH APPLICATIONS, ISAAA) (http://www.isaaa.org/). More specific examples of the plans include an herbicide-tolerant plant, a pest-resistant plant, a plant disease-resistant plant, a plant of which the quality (e.g., the increase or decrease in content or the change in composition) of a product (e.g., starch, amino acid, fatty acid, etc.) is modified, a fertility trait modified plant, a non-biological stress-tolerant plant or a plant of which a trait associated with growth or yield is modified.

Mixtures of the present invention may be applied to any plant or plant propagation material thereof that may benefit from improved growth, yield and/or quality including agricultural crops, annual grasses, trees, shrubs, ornamental flowers and the like. Mixtures of the present invention may further be applied to any area where a plant will grow including soil, a plant root zone and a furrow.

In another preferred embodiment, 6BA is applied to the plant at a rate from about 0.1 to about 100 grams per hectare (“g/HA”), more preferably from about 1 to about 20 g/HA, even more preferably from about 1 to about 5 g/HA and most preferably at about 3 g/HA.

In another preferred embodiment, the second compound is applied to the plant at a rate from about 0.1 to about 1,000 g/HA, more preferably from about 1 to about 1,000 g/HA, even more preferably from about 1 to about 100 g/HA and even more preferably from about 3 to about 60 g/HA, and most preferably at about 3, 12, 15, 24, 30, 36, 45, 54 or 60 g/HA.

In another preferred embodiment, proline is applied to the plant at a rate from about 0.1 to about 1,000 g/HA, more preferably from about 1 to about 1,000 g/HA, even more preferably from about 1 to about 100 g/HA, even more preferably from about 3 to about 54 g/HA, and yet even more preferably from about 24 to about 36 g/HA and most preferably at about 3, 12, 24, 36, or 54 g/HA.

In another preferred embodiment, malic acid is applied to the plant at a rate from about 0.1 to about 1,000 g/HA, more preferably from about 1 to about 1,000 g/HA, even more preferably from about 1 to about 100 g/HA, even more preferably from about 3 to about 60 g/HA, yet even more preferably from about 15 to about 60 g/HA and yet even more preferably from about 15 to about 30 g/HA and most preferably at about 3, 12, 24, 36, or 54 g/HA.

As used herein, the term “plant propagation material” refers to seeds and seedlings of all kinds (fruit, tubers, and grains), clonal and micro propagated plants, and the like.

As used herein, the term “soil” refers to a medium in which a plant is capable of growing.

As used herein, “composition” refers to one or more active ingredients and compounds in a carrier. The carrier may be a liquid, a semi-solid, a solid or a gas and may contain additional ingredients.

As used herein, “effective amount” refers to the amount of the mixtures of the present invention or the components therein that will improve plant growth and or plant quality. The “effective amount” will vary depending on the concentrations of the mixtures and or the components of the mixtures, the plant species or variety being treated, the result desired, and the life stage of the plants, among other factors. Thus, it is not always possible to specify an exact “effective amount.” However, an appropriate “effective amount” in any individual case may be determined by one of ordinary skill in the art.

As used herein, “improving” means that the plant has more of the quality than the plant would have had it if it had not been treated by methods of the present invention.

As used herein, “yield” refers to any measurable mass of the plant including, but not limited to, total biomass of the plant and the mass of commercially viable products of the plant.

As used herein, “plant quality” refers to measurable plant qualities that are desirable by the consumer including, but not limited to, size, texture, color, firmness, aroma, and flavor.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a,” “an” and “the” are intended to include the plural as well as the singular, unless the context clearly indicates otherwise.

The disclosed embodiments are simply exemplary embodiments of the inventive concepts disclosed herein and should not be considered as limiting, unless the claims expressly state otherwise.

### Examples

### Example 1. Mixtures of 6BA and Proline

### Method

4 field trials were conducted across 4 separate locations in Brazil. In these trials soybean plants were each treated at the V3 stage with either 6-benzyladenine (“6BA”) alone, proline alone or a mixture of 6BA and proline at the following rates: 1) surfactant treated control (“STC”); 2) 3 grams per hectare (“g/HA”) 6BA; 3) proline 3 g/HA; 4) proline 12 g/HA; 5) proline 24 g/HA; 6) proline 36 g/HA; 7) proline 54 g/HA; 8) a mixture of 3 g/HA 6BA and 3 g/HA proline; 9), a mixture of 3 g/HA 6BA and 12 g/HA proline; 10) a mixture of 3 g/HA 6BA and 24 g/HA proline; 11), a mixture of 3 g/HA 6BA and 36 g/HA proline; and 12) a mixture of 3 g/HA 6BA and 54 g/HA proline. The plants were then grown to maturity and harvested to measure grain yield. Results of these measurements can be seen in Table 1, below.

To determine if the mixtures provided unexpected results, observed combined efficacy (“OCE”) was divided by the expected combined efficacy (“ECE”) to give an OCE/ECE ratio wherein the expected ECE is calculated by the Abbott method:

$$ECE = A + B - ( A B / 100 ) ,$$

wherein ECE is the expected combined efficacy and in which A and B are the efficacy provided by the single active ingredients. If the ratio between the OCE of the mixture and the ECE of the mixture is greater than 1, then greater than expected interactions are present in the mixture. (Gisi, The American Phytopathological Society, 86:11, 1273-1279, 1996).

TABLE 1

| | Application | Yield | % Change | OCE/ECE |
|---|---|---|---|---|
| | Rate g/HA | Kg/HA | from STC | Ratio |
| STC | | 3814 | | |
| 6BA | 3 | 3949 | 3.5% | |
| Proline | 3 | 3996 | 4.8% | |
| Proline | 12 | 4078 | 6.9% | |
| Proline | 24 | 3989 | 4.6% | |
| Proline | 36 | 3939 | 3.3% | |
| Proline | 54 | 3913 | 2.6% | |
| 6BA | 3 | 3848 | 0.9% | 0.1 |
| Proline | 3 | | | |
| 6BA | 3 | 4039 | 5.9% | 0.6 |
| Proline | 12 | | | |
| 6BA | 3 | 4143 | 8.6% | 1.1 |
| Proline | 24 | | | |
| 6BA | 3 | 4182 | 9.6% | 1.4 |
| Proline | 36 | | | |
| 6BA | 3 | 3752 | −1.7% | — |
| Proline | 54 | | | |

### Results

As seen in Table 1, above, following the applications outlined above, a synergistic increase in yield was found for a mixture of 3 g/HA 6BA and 24 g/HA proline and a mixture of 3 g/HA 6BA and 36 g/HA proline. Thus, 6BA and proline provided synergistic yield at each of a 1:8 and a 1:12 concentration ratio.

### Example 2. Mixtures of 6BA and Malic Acid

### Method

4 field trials were conducted across 4 separate locations in Brazil. In these trials soybean plants were each treated at the V3 stage with either 6-benzyladenine (“6BA”) alone, malic acid alone or a mixture of 6BA and malic acid at the following rates: 1) surfactant treated control (“STC”); 2) 3 grams per hectare (“g/HA”) 6BA; 3) malic acid 3 g/HA; 4) malic acid 15 g/HA; 5) malic acid 30 g/HA; 6) malic acid 45 g/HA; 7) malic acid 60 g/HA; 8) a mixture of 3 g/HA 6BA and 3 g/HA malic acid; 9), a mixture of 3 g/HA 6BA and 15 g/HA malic acid; 10) a mixture of 3 g/HA 6BA and 30 g/HA malic acid; 11), a mixture of 3 g/HA 6BA and 45 g/HA malic acid; and 12) a mixture of 3 g/HA 6BA and 60 g/HA malic acid. The plants were then grown to maturity and harvested to measure grain yield and grains per plant. Results of these measurements can be seen in Tables 2 and 3, below.

TABLE 2

| | Application | Yield | % Change | OCE/ECE |
|---|---|---|---|---|
| | Rate g/HA | Kg/HA | from STC | Ratio |
| STC | | 4617 | | |
| 6BA | 3 | 4870 | 5.5% | |
| Malic Acid | 3 | 4590 | −0.6% | |
| Malic Acid | 15 | 4554 | −1.4% | |
| Malic Acid | 30 | 4599 | −0.4% | |
| Malic Acid | 45 | 4582 | −0.8% | |
| Malic Acid | 60 | 4733 | 2.5% | |
| 6BA | 3 | 4793 | 3.8% | 0.8 |
| Malic Acid | 3 | | | |
| 6BA | 3 | 4866 | 5.4% | 1.3 |
| Malic Acid | 15 | | | |
| 6BA | 3 | 4968 | 7.6% | 1.5 |
| Malic Acid | 30 | | | |
| 6BA | 3 | 4742 | 2.7% | 0.6 |
| Malic Acid | 45 | | | |
| 6BA | 3 | 4732 | 2.5% | 0.3 |
| Malic Acid | 60 | | | |

TABLE 3

| | Application | | % Change | OCE/ECE |
|---|---|---|---|---|
| | Rate g/HA | Grains/Plant | from STC | Ratio |
| STC | | 139 | | |
| 6BA | 3 | 135 | −3.0% | |
| Malic Acid | 3 | 135 | −3.0% | |
| Malic Acid | 15 | 145 | 4.5% | |
| Malic Acid | 30 | 137 | −1.4% | |
| Malic Acid | 45 | 136 | −2.0% | |
| Malic Acid | 60 | 141 | 1.3% | |
| 6BA | 3 | 147 | 5.6% | 0.9 |
| Malic Acid | 3 | | | |
| 6BA | 3 | 143 | 3.1% | 1.8 |
| Malic Acid | 15 | | | |
| 6BA | 3 | 146 | 5.0% | 1.1 |
| Malic Acid | 30 | | | |
| 6BA | 3 | 156 | 12.2% | 2.4 |
| Malic Acid | 45 | | | |
| 6BA | 3 | 145 | 4.6% | 2.8 |
| Malic Acid | 60 | | | |

### Results

Following the applications outlined above, a synergistic increase in yield was found for a mixture of 3 g/HA 6BA and 15 g/HA malic acid and a mixture of 3 g/HA 6BA and 30 g/HA malic acid. Thus, 6BA and malic acid provided synergistic yield at each of a 1:5 and a 1:10 concentration ratio.

Following the applications outlined above, a synergistic increase in grains per plant was found for a mixture of 3 g/HA 6BA and 15 g/HA malic acid, a mixture of 3 g/HA 6BA and 30 g/HA malic acid, a mixture of 3 g/HA 6BA and 45 g/HA malic acid and 3 g/HA 6BA and 60 g/HA malic acid. Number of grains is an indicator of yield with a greater number of grains indicating a greater yield. Thus, 6BA and malic acid provided synergistic increase in yield at each of a 1:5, a 1:10, a 1:15 and a 1:20 concentration ratio.

What is claimed is:

1. An agricultural mixture comprising 6-benzyladenine and a second compound selected from the group consisting of proline and malic acid.

2. The mixture of claim 1 wherein the second compound is proline.

3. The mixture of claim 1 wherein the second compound is malic acid.

4. The mixture of claim 1 wherein the concentration ratio of 6-benzyladenine and the second compound is from about 1:5 to about 1:20.

5. The mixture of claim 1 wherein the concentration ratio of 6-benzyladenine and the second compound is from about 1:5 to about 1:10.

6. The mixture of claim 1 wherein the concentration ratio of 6-benzyladenine and the second compound is from about 1:8 to about 1:12.

7. An agricultural composition comprising 6-benzyladenine, a second compound selected from the group consisting of proline and malic acid and a carrier.

8. A method of increasing plant growth comprising applying sequentially or concurrently an effective amount of a mixture of claim 1 to the plant or an area where the plant will grow.

9. The method of claim 8, wherein the plant is a soybean plant.

10. A method of increasing plant yield comprising applying sequentially or concurrently an effective amount of a mixture of claim 1 to the plant or an area where the plant will grow.

11. The method of claim 10, wherein the plant is a soybean plant.

12. A method of increasing plant quality comprising applying sequentially or concurrently an effective amount of a mixture of claim 1 to the plant or an area where the plant will grow.

13. The method of claim 12, wherein the plant is a soybean plant.
